(19) United States
(12) Patent Application Publication
(10) Pub. No.: US 2006/0071472 A1
(43) Pub. Date: Apr. 6, 2006

(54) Siphon for toilets

(76) Inventor: Sergio Pasotti, Lumezzane (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/505,611

(22) PCT Filed: Feb. 14, 2003
(86) PCT No.: PCT/EP03/01480

§ 371 Date: Feb. 22, 2005

(30) Foreign Application Priority Data
Feb. 22, 2002 (IT) MI02U000086

(51) Int. Cl. F16L 27/00

(52) U.S. Cl. 285/272

(57) ABSTRACT

The siphon for toilets comprises a first tubular element (2) for connecting a discharge of the toilet and a second tubular element (4) for connecting to a wall discharge pipe. The first tubular element and the second tubular element are rotatably connected together water-tight, so as to be able to be rotated between a low-bulk transportation position and an installation position with the tubular elements extended.

The present finding refers to a siphon for toilets.

As is known, all toilets are equipped with a siphon which prevents the backflow of odours or anything else.

In particular, conventional siphons are made up of a tubular element connected to the outlet of the toilet and another tubular element connected to the wall discharge pipe.

The aforementioned two tubular elements are disconnected from each other and are connected together when the siphon is installed.

For this reason, conventional siphons have numerous drawbacks mainly due to the fact that they are produced and commercialised in separate elements, to be joined when the siphon is installed.

This, if on the one hand it allows bulk to be cut down for transportation and commercialisation, on the other hand it causes high production and installation costs due to the high number of pieces necessary (which foresees, besides the tubular elements, also connection elements between the two tubular elements).

It is also possible that when the siphon is assembled some pieces may be damaged or else lost and in this case the siphon could not carry out its function of transportation of flush water to its best ability or even it may not be able to complete its function at all.

Moreover, when installed the elements must be assembled, with substantial loss in time and, usually, with the use of professional tools, to ensure perfect couplings avoiding leakages of flush water.

This, in practice, requires that the installation be carried out by a specialised expert.

The task proposed of the present invention is, therefore, that of realising a siphon for toilets which allows the aforementioned technical drawbacks of the prior art to be eliminated.

In this task a purpose of the finding is that of realising a siphon which has limited production and installation costs.

Another purpose of the finding is that of realising a siphon which does not have the danger of some of its pieces being lost before or during assembly, preventing it from carrying out its function to its best or requiring its replacement. This is so because, advantageously, the siphon according to the present finding is not made up of numerous separate pieces which must be assembled when installed, but is already assembled and prepared for being connected to the toilet at the production stage.

The last but not least purpose of the finding is that of realising a siphon which can be installed in a short period of time, without the help of professional tools. Moreover, advantageously, the siphons according to the present finding can even be installed by somebody who is not a specialised expert.

The task as well as these and other purposes according to the present finding are achieved by realising a siphon for toilets comprising a first tubular element for connecting to a discharge of said toilet and a second tubular element for connecting to a wall discharge pipe, characterised in that said first tubular element and said second tubular element are rotatably connected together water-tight, so as to be able to be rotated between a low-bulk transportation position and an installation position with the tubular elements extended.

Other characteristics of the present finding are, moreover, defined in the subsequent claims.

Further characteristics and advantages shall become clearer from the detailed description of the siphon for toilets according to the finding, illustrated for indicating purposes in the attached figures, in which:

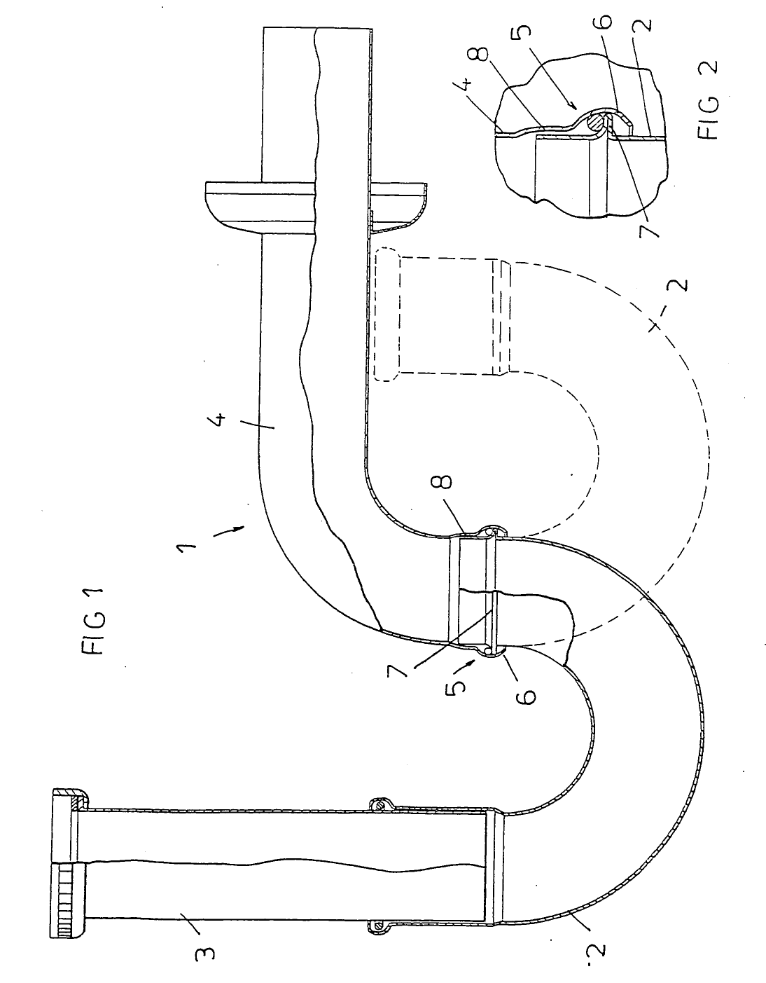

FIG. 1 shows a longitudinal section view of a P-bend according to the present finding;

FIG. 2 shows a section view of a detail of the connection between a first and second tubular element of the siphon of FIG. 1;

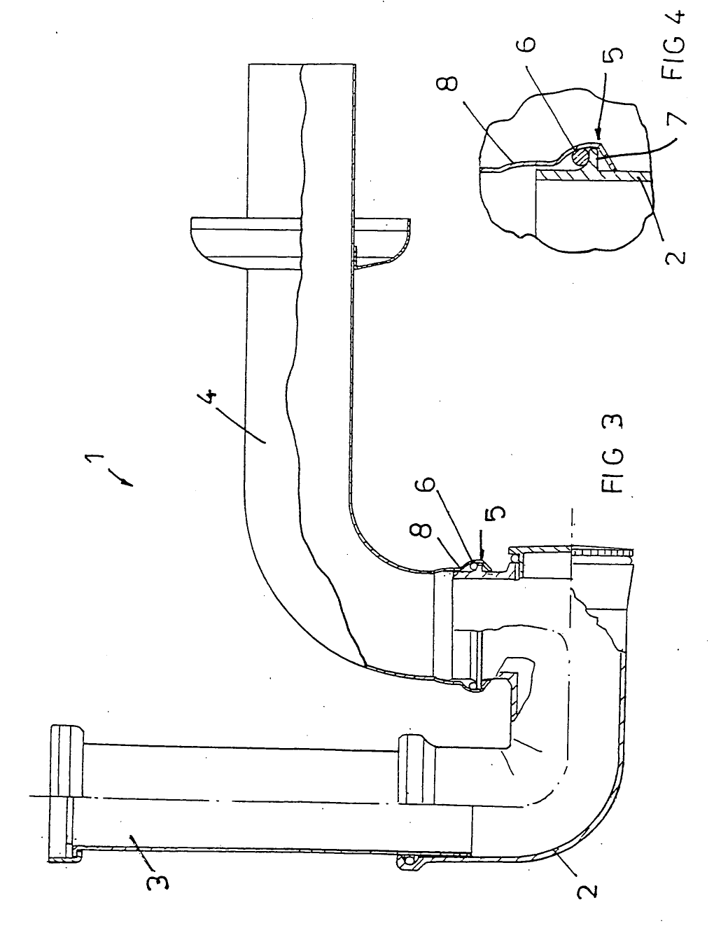

FIG. 3 shows a longitudinal section view of a siphon according to the present finding; and

FIG. 4 shows a section view of a detail of the connection between the first and second tubular element of the siphon of FIG. 3.

With reference to the quoted figures, a siphon for toilets is shown, wholly indicated with reference numeral 1.

The siphon 1 comprises a first tubular element 2 for connecting to a discharge 3 of said toilet and a second tubular element 4 for connecting to a wall discharge pipe.

Advantageously, the first tubular element 2 and the second tubular element 4 are rotatably connected together water-tight, so as to be able to be rotated between a low-bulk transportation position (represented in FIG. 1 with a broken line) and an installation position (represented in FIG. 1 with a continuous line) with the tubular elements 2, 4 extended.

The second tubular element 4 has at one of its ends at least one circular seat 5 in which an end of said first tubular element is inserted or vice-versa, i.e. the circular seat can be arranged at the end of the first tubular element 2.

The circular seat 5 comprises a first widened portion 6 of the second tubular element 4 in which a flange 7 of the first tubular element 2 is housed or vice-versa.

In practice, the widened portion 6 is rimmed to prevent the slipping of the tubular element 2. In a different example the widened portion 6 can be arranged on the first tubular element 2 and the flange 7 can be arranged on the second tubular element 4.

Preferably, the flange 7 has at least one portion in sliding contact with the first widened portion 6 for applying a friction action.

As shown for example in FIGS. 1 and 2, the flange 7 comprises at least one bent portion of the first or second tubular element 2, 4. In a different embodiment shown in FIGS. 3 and 4, on the other hand, the flange is realised through a radial profile.

Advantageously, the first widened portion 6 is substantially C-shaped.

Moreover, between said first widened portion 6 and the first tubular element 2 (in particular its flange 7) a sealing element 8 is housed, for example-consisting of an O-ring.

The circular seat 5 comprises a second widened portion 8, adjacent to said first widened portion 6, for housing an end portion 9 of the first tubular element 2 (or of the second tubular element 4 if the seat 5 is arranged on the first tubular element 2).

Preferably, the first tubular element 2 comprises a U-shaped portion.

The operation of the siphon for toilets according to the finding is clear from that which has been described and illustrated and, in particular, is substantially carried out as indicated hereafter.

The packaging, transportation and commercialisation of the siphon according to the present finding take place with the siphon in low-bulk configuration (broken line in FIG. 1), so as to make such operations easier and more cost-effective. Then, to carry out the installation, the first tubular element 2 is rotated with respect to the second tubular element 4 taking them into the configuration shown with a continuous line in FIG. 1.

Moreover, just as simply, it is possible to position the first and second tubular elements 2, 4 according to any angulations to connect the toilet to the discharge in a simple and quick manner without limitations set by the particular positioning of the toilet with respect to the discharge.

In practice, it has been noted how the siphon for toilets according to the finding is particularly advantageous since it allows the transportation and installation of the siphon to be simplified and speeded up and, at the same time, allowing the production, packaging, transportation and installation costs to be reduced.

In practice, the materials used as well, as the sizes, can be whatever according to the requirements and the state of the art.

1. Siphon for toilets comprising a first tubular element for connecting to a discharge of said toilet and a second tubular element for connecting to a wall discharge pipe, characterised in that said first tubular element and said second tubular element are rotatably connected together water-tight, so as to be able to be rotated between a low-bulk transportation position and an installation position with the tubular elements extended.

2. Siphon according to claim 1, characterised in that said second tubular element has at one of its ends at least one circular seat in which an end of said first tubular element is inserted, or vice-versa.

3. Siphon according to claim 1, characterised in that said circular seat comprises a first widened portion of said second tubular element in which a flange of said first tubular element is housed, or vice-versa.

4. Siphon according to claim 1, characterised in that said flange has at least one portion in sliding contact with said first widened portion.

5. Siphon according to claim 1, characterised in that said flange comprises at least one bent portion of said first or second tubular element.

6. Siphon according to claim 1, characterised in that said first widened portion is substantially C-shaped.

7. Siphon according to claim 1, characterised in that between said first widened portion and said first tubular element a sealing element is housed.

8. Siphon according to claim 1, characterised in that said circular seat comprises a second widened portion adjacent to said first widened portion to house an end portion of said first or second tubular element.

9. Siphon according to claim 1, characterised in that said first tubular element comprises a U-shaped portion.

10. (canceled)
